(19) United States
(12) Patent Application Publication
(10) Pub. No.: US 2019/0147100 A1
(43) Pub. Date: May 16, 2019

(54) METHOD AND APPARATUS FOR ESTABLISHING INTELLIGENT QUESTION ANSWERING REPOSITORY, AND INTELLIGENT QUESTION ANSWERING METHOD

(71) Applicant: Shanghai Xiaoi Robot Technology Co., Ltd., Shanghai (CN)

(72) Inventors: Bo LI, Shanghai (CN); Jie CHENG, Shanghai (CN); Zhongqiu JIANG, Shanghai (CN); Gongzhi YAO, Shanghai (CN); Yongmei ZENG, Shanghai (CN); Pinpin ZHU, Shanghai (CN)

(21) Appl. No.: 16/106,533

(22) Filed: Aug. 21, 2018

(30) Foreign Application Priority Data
Nov. 10, 2017 (CN) 201711106468.9
Nov. 22, 2017 (CN) 201711172161.9
Nov. 22, 2017 (CN) 201711172532.3

(51) Int. Cl. G06F 17/30; G06N 5/02

(52) U.S. Cl. CPC G06F 17/30654; G06F 17/30294; G06N 5/022

(57) ABSTRACT

A method for establishing an intelligent question answering repository comprises: obtaining structured data including a title, a header and a table body; determining two or more sorts of attribute information corresponding to the table body from the header, each of the two or more sorts of attribute information corresponding to header contents of one or more columns; generating one or more question and answer knowledge points according to the attribute information, each question and answer knowledge point including a question expression and an answer expression, and the answer expression including the title; and storing the structured data, the question and answer knowledge points and the attribute information into a repository.

### CROSS-REFERENCE TO RELATED APPLICATIONS

The present application claims priority to Chinese Patent Application No. 201711106468.9 filed on Nov. 10, 2017, Chinese Patent Application No. 201711172532.3 filed on Nov. 22, 2017 and Chinese Patent Application No. 201711172161.9 filed on Nov. 22, 2017, all contents of which are incorporated by reference herein.

### TECHNICAL FIELD

Embodiments of the present invention relate to an intelligent question answering technology, and in particular to a method and an apparatus for establishing an intelligent question answering repository, and an intelligent question answering method.

### BACKGROUND

In the intelligent question answering system, some of knowledge points do not come from simple question-answer pairs, but from structured data realized by some two-dimensional table structures. The amount of the structured data is huge. The financial table shown in Table 1 corresponds to about 8*5 knowledge points (such as the annual interest rate of 90 days in the Zengli series). The knowledge points include questions and answers. The amount of knowledge is huge, and each knowledge point needs manual organization by an operator.

TABLE 1
Financial Table

| Financial product | | | | | |
|---|---|---|---|---|---|
| series | 90 days | 7 days | 45 days | 30 days | 120 days |
| Zengli series | 4.18 | 2.25 | | 3.15 | 46.5 |
| Dianshichengjin series | 4.46 | 2.31 | | 3.16 | 4.96 |
| Yinkuihua series | 4.17 | 2.71 | 3.67 | 3.17 | 4.67 |
| Ririying series | 4.06 | 2.39 | | 3.31 | 4.56 |
| Tiantianli series | 4.13 | 2.25 | | 3.26 | 4.91 |
| Siyin series | | 2.19 | | 3.31 | |
| Xinjin Financial series | 4.58 | 2.91 | 3.79 | 3.28 | 4.98 |
| Jinlin Financial series | 4.21 | 2.27 | 3.91 | 3.41 | 4.96 |

If the contents of the table are modified in large quantities, the operator needs to find the answers corresponding to knowledge points and make changes one by one, which is not only a heavy workload, but also easy to make mistakes.

### SUMMARY

Embodiment of the present invention are directed toward an apparatus and a method for establishing an intelligent question answering repository, and an intelligent question answering method, which can realize automatic generation of knowledge points, reduce workload of operators and improve accuracy of the knowledge points.

The first aspect of the present invention provides a method for establishing an intelligent question answering repository, the method comprises: obtaining structured data including a title, a header and a table body; determining two or more sorts of attribute information corresponding to the table body from the header, each of the two or more sorts of attribute information corresponding to header contents of one or more columns; generating one or more question and answer knowledge points according to the attribute information, each question and answer knowledge point including a question expression and an answer expression, and the answer expression including the title; and storing the structured data, the question and answer knowledge points and the attribute information into a repository.

In an embodiment, the structured data comprises a static two-dimensional table, the obtaining structured data including a title, a header and a table body comprises: obtaining a static two-dimensional table including a title, a header and a table body, the header being the first row of the static two-dimensional table, and the table body being rows other than the first row of the static two-dimensional table; and the storing the structured data, the question and answer knowledge points and the attribute information into a repository comprises: storing the static two-dimensional table, the question and answer knowledge points and the attribute information into a repository.

In an embodiment, the structured data comprises a dynamic database table, the obtaining structured data including a title, a header and a table body comprises: obtaining a dynamic database table including a title, a header and a table body, the header being the first row of the dynamic database table, and the table body being rows other than the first row of the dynamic database table; and the storing the structured data, the question and answer knowledge points and the attribute information into a repository comprises: storing link information of a database corresponding to the dynamic database table, the question and answer knowledge points and the attribute information into a repository.

In an embodiment, the determining two or more sorts of attribute information corresponding to the table body from the header comprises: when attributes corresponding to header contents of multiple columns of data are the same, summarizing the header contents of the multiple columns of data into one sort of attribute information; and when header contents of only one column of data correspond to one attribute, directly taking the header contents of the one column data as one sort of attribute information.

In an embodiment, the method further comprises: establishing an inclusion relationship between the attribute information and the header contents or corresponding contents in the table body; and storing the inclusion relationship into the repository.

In an embodiment, the method further comprises: establishing word classes for words in the header or/and the table body, the words being used as word class names of corresponding word classes, the word classes including the words and synonyms of the words; wherein the establishing an inclusion relationship between the attribute information and corresponding contents in the table body comprises: establishing an inclusion relationship between the attribute information and corresponding word class names in the table body or header; and the storing the inclusion relationship into the repository further comprises: storing the word classes into the repository.

In an embodiment, the generating one or more question and answer knowledge points according to the attribute information comprises: automatically generating an initial knowledge point according to at least two sorts of the attribute information; and adjusting each initial knowledge point to obtain a question and answer knowledge point.

In an embodiment, the repository further comprises common knowledge points, the common knowledge points comprise question expressions and answer expressions, and the answer expressions do not include the title.

The second aspect of the present invention provides an intelligent question answering repository, which is established by the method for establishing the intelligent question answering repository described in any embodiment of the present invention.

The third aspect of the present invention provides an intelligent question answering method based on the repository according to any embodiment of the present invention, the method comprises: when receiving request information from a user, matching question and answer knowledge points in a repository according to the request information; obtaining corresponding structured data according to a title corresponding to matched question and answer knowledge points; searching a corresponding answer in the structured data according to the request information, and generating a final answer according to a searched answer and a determined answer expression; and returning the final answer to the user.

In an embodiment, the matching question and answer knowledge points in a repository according to the request information comprises: matching the request information from a user with question and answer knowledge points in the repository according to semantic similarity calculation, and selecting one or more question and answer knowledge points whose similarities are greater than a preset threshold and the highest as matched question and answer knowledge points.

In an embodiment, the semantic similarity calculation is performed by word segmentation on the request information and is calculated based on word classes established by a word segmentation result.

In an embodiment, the obtaining corresponding structured data according to a title corresponding to matched question and answer knowledge points comprises: searching a corresponding static two-dimensional table or link information of a database corresponding to a corresponding dynamic database table according to the title; and obtaining a searched static two-dimensional table, or obtaining a corresponding dynamic database table according to the link information.

The fourth aspect of the present invention provides a method for modifying the repository described in any embodiment of the present invention, the method comprising: obtaining structured data; modifying the structured data stored in a repository according to received modification instructions; and modifying question and answer knowledge points and corresponding attribute information in the repository according to the modification.

In an embodiment, the modification instruction include: at least one of modifying the title, modifying the header content, modifying the table body content, increasing the entire column data, increasing the entire row data of the table body, deleting the entire row data of the table body, and deleting the entire column data.

In an embodiment, the modifying question and answer knowledge points and corresponding attribute information in the repository according to the modification includes: when the modification is to modify the title, modifying the title in the answer expression of the corresponding question and answer knowledge point; and when the modification includes modifying, adding, and deleting the header content, modifying the corresponding attribute information and corresponding question and answer knowledge points.

The fifth aspect of the present invention provides an apparatus for establishing an intelligent question answering repository, the apparatus comprises: a processor; a memory for storing instructions executable by the processor; wherein the processor executes the instructions to perform the following steps: obtaining structured data including a title, a header and a table body; determining two or more sorts of attribute information corresponding to the table body from the header, each of the two or more sorts of attribute information corresponding to header contents of one or more columns; generating one or more question and answer knowledge points according to the attribute information, each question and answer knowledge point including a question expression and an answer expression, and the answer expression including the title; and storing the structured data, the question and answer knowledge points and the attribute information into a repository.

In an embodiment, the structured data comprises a static two-dimensional table, the obtaining structured data including a title, a header and a table body comprises: obtaining a static two-dimensional table including a title, a header and a table body, the header being the first row of the static two-dimensional table, and the table body being rows other than the first row of the static two-dimensional table; and the storing the structured data, the question and answer knowledge points and the attribute information into a repository comprises: storing the static two-dimensional table, the question and answer knowledge points and the attribute information into a repository.

In an embodiment, the structured data comprises a dynamic database table, the obtaining structured data including a title, a header and a table body comprises: obtaining a dynamic database table including a title, a header and a table body, the header being the first row of the dynamic database table, and the table body being rows other than the first row of the dynamic database table; and the storing the structured data, the question and answer knowledge points and the attribute information into a repository comprises: storing link information of a database corresponding to the dynamic database table, the question and answer knowledge points and the attribute information into a repository.

In an embodiment, the determining two or more sorts of attribute information corresponding to the table body from the header comprises: when attributes corresponding to header contents of multiple columns of data are the same, summarizing the header contents of the multiple columns of data into one sort of attribute information; and when header contents of only one column of data correspond to one attribute, directly taking the header contents of the one column data as one sort of attribute information.

In an embodiment, the processor executes the instructions to further perform the follow steps: establishing an inclusion relationship between the attribute information and the header contents or corresponding contents in the table body; and storing the inclusion relationship into the repository.

In an embodiment, the processor executes the instructions to further perform the follow step: establishing word classes for words in the header or/and the table body, the words being used as word class names of corresponding word classes, the word classes including the words and synonyms of the words; wherein the establishing an inclusion relationship between the attribute information and corresponding contents in the table body comprises: establishing an inclusion relationship between the attribute information and corresponding word class names in the table body or header; and the storing the inclusion relationship into the repository further comprises: storing the word classes into the repository.

In an embodiment, the generating one or more question and answer knowledge points according to the attribute information comprises: automatically generating an initial knowledge point according to at least two sorts of the attribute information; and adjusting each initial knowledge point to obtain a question and answer knowledge point.

In an embodiment, the repository further comprises common knowledge points, the common knowledge points comprise question expressions and answer expressions, and the answer expressions do not include the title.

The sixth aspect of the present invention provides an intelligent question answering apparatus based on the repository according to any embodiment of the invention, the apparatus comprises: a processor; a memory for storing instructions executable by the processor; wherein the processor executes the instructions to perform the following steps: when receiving request information from a user, matching question and answer knowledge points in a repository according to the request information; obtaining corresponding structured data according to a title corresponding to matched question and answer knowledge points; searching a corresponding answer in the structured data according to the request information, and generating a final answer according to a searched answer and a determined answer expression; and returning the final answer to the user.

In an embodiment, the matching question and answer knowledge points in a repository according to the request information comprises: matching the request information from a user with question and answer knowledge points in the repository according to semantic similarity calculation, and selecting one or more question and answer knowledge points whose similarities are greater than a preset threshold and the highest as matched question and answer knowledge points.

In an embodiment, the semantic similarity calculation is performed by word segmentation on the request information and is calculated based on word classes established by a word segmentation result.

In an embodiment, the obtaining corresponding structured data according to a title corresponding to matched question and answer knowledge points comprises: searching a corresponding static two-dimensional table or link information of a database corresponding to a corresponding dynamic database table according to the title; and obtaining a searched static two-dimensional table, or obtaining a corresponding dynamic database table according to the link information.

The seventh aspect of the present invention provides an apparatus for modifying an intelligent question answering repository described in any embodiment of the present invention, the apparatus comprises: a processor; a memory for storing instructions executable by the processor; wherein the processor executes the instructions to perform the following steps: obtaining structured data; modifying the structured data stored in a repository according to received modification instructions; and modifying question and answer knowledge points and corresponding attribute information in the repository according to the modification.

In an embodiment, the modification instruction include: at least one of modifying the title, modifying the header content, modifying the table body content, increasing the entire column data, increasing the entire row data of the table body, deleting the entire row data of the table body, and deleting the entire column data.

In an embodiment, the modifying question and answer knowledge points and corresponding attribute information in the repository according to the modification includes: when the modification is to modify the title, modifying the title in the answer expression of the corresponding question and answer knowledge point; and when the modification includes modifying, adding, and deleting the header content, modifying the corresponding attribute information and corresponding question and answer knowledge points.

The eighth aspect of the present invention provides a terminal device, which comprises one or more processors and a storage apparatus for storing one or more programs, the one or more programs are executed by the one or more processors to implement the method for establishing an intelligent question answering repository according to any embodiment of the present invention.

The ninth aspect of the present invention provides a computer storage medium on which computer programs are stored, the computer programs are executed by a processor to implement the method for establishing an intelligent question answering repository as described in any embodiment of the present invention.

The tenth aspect of the present invention provides a terminal device, which comprises one or more processors and a storage apparatus for storing one or more programs, the one or more programs are executed by the one or more processors to implement the method for modifying a repository according to any embodiment of the present invention.

The eleventh aspect of the present invention provides a computer storage medium on which computer programs are stored, the computer programs are executed by a processor to implement the method for modifying a repository as described in any embodiment of the present invention.

In the method for establishing an intelligent question answering repository according to the embodiment of the present invention, two or more sorts of attribute information corresponding to the table body are determined from the header of the structured data by obtaining structured data, one or more question and answer knowledge points are generated according to the attribute information. Each question and answer knowledge point includes a question expression and an answer expression, and the answer expression includes the title. The structural data, question and answer knowledge points and attribute information are stored into the repository. In this way, automatic generation of knowledge points based on the structured data and the establishment of the corresponding repository are realized, which reduces the workload of operators and the possibility of human error, and improves the accuracy and efficiency of generating knowledge points. When modifying the structured data, it is not necessary to modify every knowledge point generated by manual sorting as in the prior art, only the question and answer knowledge point corresponding to changed attribute information, thus greatly reducing the workload of the operator.

### BRIEF DESCRIPTION OF DRAWINGS

The above and other aspects of the present invention will become more apparent from the following detailed description when taken in conjunction with the accompanying drawings in which:

FIG. 1 is a flowchart illustrating a method for establishing an intelligent question answering repository according to an embodiment of the present invention;

FIG. 2 is a flowchart illustrating a method for establishing an intelligent question answering repository according to another embodiment of the present invention;

FIG. 3 is a flowchart illustrating a method for establishing an intelligent question answering repository according to still another embodiment of the present invention;

FIG. 4 is a schematic diagram illustrating establishing word classes for a primary key column of Table 1 in a method for establishing an intelligent question answering repository according to an embodiment of the present invention;

FIG. 5 is a schematic diagram illustrating establishing word classes for column headings of other columns of Table 1 in a method for establishing an intelligent question answering repository according to an embodiment of the present invention;

FIG. 6 is a flowchart illustrating an intelligent question answering method according to an embodiment of the present invention;

FIG. 7 is a flowchart illustrating an intelligent question answering method according to another embodiment of the present invention;

FIG. 8 is a flowchart illustrating an intelligent question answering method according to still another embodiment of the present invention;

FIG. 9 is a flowchart illustrating a method for modifying an intelligent question answering repository according to an embodiment of the present invention;

FIG. 10 is a schematic structural diagram illustrating an apparatus for establishing an intelligent question answering repository according to an embodiment of the present invention;

FIG. 11 is a schematic structural diagram illustrating an intelligent question answering apparatus according to an embodiment of the present invention;

FIG. 12 is a schematic structural diagram illustrating an apparatus for modifying an intelligent question answering repository according to an embodiment of the present invention; and

FIG. 13 is a schematic structural diagram illustrating a terminal device according to an embodiment of the present invention.

### DETAILED DESCRIPTION

In the following detailed description, embodiments will be described with reference to the accompanying drawings. However, the present invention may be embodied in various different forms, and should not be construed as being limited only to the illustrated embodiments. Rather, these embodiments are provided as examples, simply by way of illustrating the concept of the present invention to those skilled in the art. Accordingly, processes, elements, and techniques that should be apparent to those of ordinary skill in the art are not described herein.

In order to facilitate the understanding of the contents of the embodiments of the present invention, the nouns commonly used in intelligent question answering will be first introduced:

1 Knowledge Point

The most primitive and simplest form of basic knowledge points in a repository is the commonly used Frequently Asked Questions (FAQ). The general form is the “question-answer” pair. For example, “charges of coloring ring back tones (CRBT)” is a clear standard description. The “question” here may not be narrowly understood as “inquiry”, but rather may be broadly understood as an “input” having a corresponding “output”. For example, for semantic recognition used for controlling a system, an instruction from a user such as “turn on the radio” may also be understood as a “question”, and the corresponding “answer” at this time may be a call to a control program for executing the corresponding control.

When the user inputs to the machine, the ideal situation is to use a standard question, then an intelligent semantic recognition system of a machine may immediately understand the meaning of the user. However, users often do not use the standard questions, but some variants of standard questions. For example, if the standard form for radio station switching is “change a station”, then a user may use the command “switch a station”, and the machine needs to be able to recognize that the user is expressing a same meaning as “change a station”.

For intelligent semantic recognition, the repository needs to have extension questions of standard questions. The extension questions are slightly different from the standard questions in expression form, but they express the same meanings.

Therefore, the repository includes multiple knowledge points. Each knowledge point includes a question and an answer, and the question includes a standard question and multiple extension questions.

2 Word Class

Word classes are divided according to the semantics of words. A group of related words are organized together to form a tree-like word class library. Any non-leaf node in the tree-like structure is called a word class (generalized word class), and the first-level word class that directly contains words is called a narrow word class. The purpose of defining a word class is mainly to segment words, construct semantic expressions, and use the semantic information carried by the word class to perform semantic similarity calculation.

2.1 the Composition of the Word Class

The word class (narrow word class) is a summary of a group of related words. The word class consists of a word class name and a group of related words. The word class name is a word that has a label function in this group of related words, i.e. a representative of the word class. A word class contains at least one word (i.e. the word class name itself). A word class name generally needs to meet the following rules: the word class name should be simple and clear, easy to understand, and may highlight the key; when a group of words includes pinyin, English, internet buzzwords, dialects, written languages and other words, mandarin can be commonly used as a word class name; the word class name should not contain any symbols (such as “/”, “?”, etc.).

2.2 Semantic Annotation of the Word Class

If the word class is used only by a class of words, its meaning will be greatly reduced. In order to make a better use of the word class, it is necessary to define its default semantic information and mark other semantic information. With the semantic information, various operations can be performed in the subsequent semantic analysis. The marked semantics has an inheritance property, that is, subclasses inherit the annotation semantics of parent classes.

2.2.1 Un-Annotated Word Class

By default, semantics without any annotations is defined as “similar”, which can be understood as a synonym. This kind of word class plays a great role in the subsequent semantic calculation. Such word classes are extensively used in semantic expressions, for example, the word class “open” includes “open”, “customize”, “activate” and the like.

2.2.2 Collective Word (#)

Collection words can be marked as “dissimilar” using “#”. At this time, the main function of the word class is to express semantic expressions. Collection words are generally represented as the same type of words and have certain semantic relevance, but they are not synonymous and are called collective words. For example, the word class “operating system” includes “wince”, “linux”, “IOS”, “Android”, “palm”, “Symbian” and the like.

2.2.3 Important Word (*n)

Important words can be marked as “important” (n indicates the importance) using “*” or “n”. This kind of words should be weighted relative to other words in the process of similarity calculation. In general, business terminology needs to be semantically marked more important to strengthen the weight in the similarity calculation. For example, the word class “coloring ring back tones” includes words such as “colorful ringtones” and “coloring ring back tones”.

2.2.4 Name (% n)

Parts of speech of some professional words can be marked using “% n”. Such words generally have specific meanings in a certain field. It is easy to make a misjudgment when parts of speech are marked. Therefore, it needs to be corrected by manual labeling. An accurate part of speech can play an important role in subsequent sentence pattern analysis and similarity calculation. For example, the word class “multimedia message (MMS) favorites folder” includes the words “multimedia message favorites folder” and “multimedia message collection folder”.

2.2.5 Verb (% v)

Parts of speech of some verbs can be marked using “% v”.

2.2.6 Pinyin Error Correction Word (@)

Word classes of some professional words can be marked using “@” for pinyin correction. If pinyin correction is performed in all thesauruses, the accuracy of error correction is often low due to homophones. Although the range of error correction becomes smaller by partially correcting the words in the specified part, the accuracy of error correction can be greatly improved. The annotation of “error correction” is generally aimed at professional nouns in the field. The length of a professional noun is often longer than that of a common word, and generally there is no homophone, thus the effect of error correcting is obvious. Since professional nouns often contain some other words, the principle of automatic error correction is that the influence of error correction on the number of word segmentation results cannot be increased. For example, the word “Preferably read membership package” (Chinese pinyin is: yue du hui hui yuan bao), which is often mistakenly input the “reading membership package” (Chinese pinyin is also: yue du hui hui yuan bao) due to the input method, such incomprehension of user's question caused by user input errors can be avoided by pinyin correction.

It should be noted that the above annotations are merely illustrative examples. For example, the reference symbols and/or the corresponding relationships may be changed, which does not affect the protection scope of the present invention.

3 Semantic Expressions

Semantic expressions are mainly composed of words, word classes and their “or” relationships. The core of the semantic expressions depends on the “word class”. A simple understanding of a word class is a group of common words. These words may or may not be semantically similar. These words can also be marked as important or not important. The relationship between a semantic expression and a user question is very different from traditional template matching. In the traditional template matching, the relationship between the template and the user question is only matched and unmatched. However, the relationship between the semantic expression and the user question is expressed by a quantified value (similarity), and the quantified value can be compared with the similarity between a similar question and the user question. Since a semantic expression should be involved in similarity calculation together with similar questions, the definition of template grammars should not be complicated, but should have sufficient ability to express semantics. The specific composition of the semantic expressions and the representation of symbols will be illustrated by the following examples.

3.1 Symbols in Semantic Expressions

3.1.1 Representation of the Word Class ([ ])

To distinguish words from word classes in expressions, it is stipulated that the word class must appear in a square bracket “[ ]”. The word class appearing in the square bracket is generally a “narrow word class”, but system parameters can also be configured to support a “generalized word class”. Here are some examples of simple expressions: [Fetion] [how] [open], [introduction] [MMS] [business], [Fetion] [login] [method] and [call reminder] [how] [charge].

3.1.2 Representation of “or” Relationship (|)

The word class in the square bracket can appear multiple times through the “or” relationship. These word classes of “or” relationship will be calculated separately in an “expansion” manner when the similarity is calculated. “Expansion” is mainly the process of expanding a semantic expression into multiple simple expressions based on the meaning of “or”. For example, [method| steps] of [CRBT] [open] can be expanded into two simple semantic expressions: [steps] of [CRBT] [open] and [method] of [CRBT] [open]. Examples of such semantic expressions are as follows: [method| steps] of [CRBT] [open], [how] [query| know] [PUK (Personal Unlock Key) code], [unsubscribe| cancel| close| disable] [IP| 17951] [domestic long-distance discount package] and [call reminder] [function fee| monthly fee| information fee| communication fee].

3.1.3 Unnecessary Representation (?)

Word classes in square brackets can be added with “?” at the end to indicate that they may or may not appear, that is, unnecessary relationships. The word classes of such unnecessary relational will also be separately calculated in the “expansion” manner when calculating the similarity. “Expansion” is mainly a process of expanding a semantic expression with an unnecessary word class (or “or combination” of word classes) into two simple semantic expressions that contain and do not contain the word class.

For example, the expression [introduction] [mobile video] [military column] [content] [what?] can be expanded into two simple semantic expressions: [introduction] [mobile video] [military column] [content] and [introduction] [mobile video] [military column] [content] [what].

The question expressions and answer expressions in embodiments of the present invention are questions and answers expressed in the form of expressions.

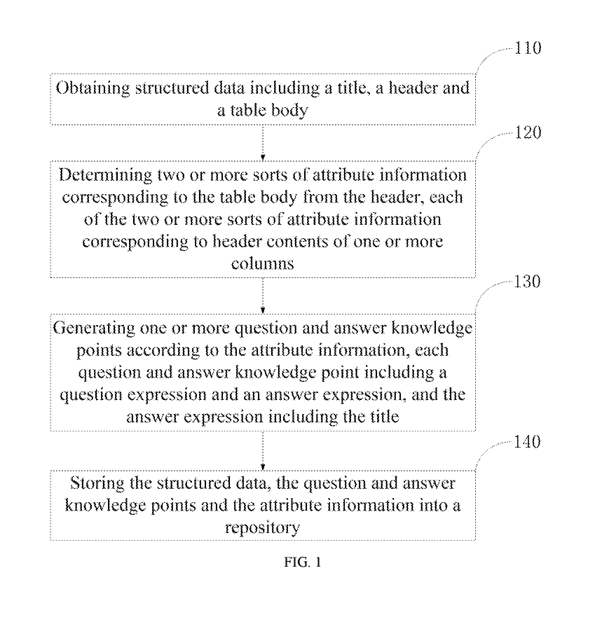

FIG. 1 is a flowchart illustrating a method for establishing an intelligent question answering repository according to an embodiment of the present invention. This embodiment may be applied to establishing an intelligent question answering repository on structured data. The method may be implemented by an apparatus for establishing the intelligent question answering repository. The apparatus can be implemented by software and/or hardware and can generally be integrated in a terminal device. As shown in FIG. 1, the method specifically includes the following steps:

Step 110: obtaining structured data including a title, a header and a table body.

The structured data is data logically expressed and realized by a two-dimensional table structure, follows data formats and length specifications, and is mainly stored and managed by a relational database. The structured data may optionally include a static two-dimensional table or a dynamic database table. The structured data implemented in the two-dimensional table structure includes a title (such the title “Financial Table” in Table 1), a header (such as the first row in Table 1) and a table body (data other than the first row).

Step 120: determining two or more sorts of attribute information corresponding to the table body from the header, each of the two or more sorts of attribute information corresponding to header contents of one or more columns.

The header of the structured data represents the attribute of each column of data. Generally, the primary key column contains one attribute. The attributes of other columns of data may be the same or different. The two or more sorts of attribute information corresponding to the table body can be determined according to the attribute of each column of data, and each sort of attribute information represents an attribute and corresponds to the header contents of one or more columns.

The primary key column is a column that can uniquely identify one row of data in a table. For example, the first column in Table 1 can identify the specific financial product represented by each row, which is the primary key column.

During the specific implementation, the attribute of each column of data is determined according to the header contents. The primary key column (such as the first column of Table 1 and the first column of Table 2) is selected, a sort of attribute information is determined according to the primary key column, and then one or more sorts of attribute information are determined according to header contents of other columns (for example, the header contents of other columns in Table 1 are specific days, which can be summarized into a sort of attribute information; and the header contents of other columns in Table 2 cannot be summarized into a sort of attribute information, and each column can be regarded as a sort of attribute information). It is also necessary to judge whether the loaded structured data can be constructed as a knowledge point based on the determined attribute information. Specifically, only one knowledge point can be constructed when there are two sorts of attribute information, and multiple knowledge points can be constructed when there are more than two sorts of attribute information. For example, Table 1 can be constructed as a knowledge point, and Table 2 can be constructed as multiple knowledge points including: the price of book xx, the author of book xx and the introduction of book xx, among which xx is collectively referred to as all books.

TABLE 2
Book Table

| Book Name | Author Name | Price | Introduce |
|---|---|---|---|
| The Ordinary | Lu Yao | 55 | “The Ordinary World” (3 volumes) is a |
| World | | | realist novel and a novelized family |
| | | | history. The writer highly concentrates |
| | | | the historical process of the countryside |
| | | | in the northwest of China. The work |
| | | | reached a high degree of unity between |
| | | | ideological and artistic. In particular, the |
| | | | protagonist's spirit of hard struggle in |
| | | | the face of difficulties still inspires the |
| | | | current college students . . . |
| Life | Lu Yao | 20 | “Life” is a novella of Lu Yao, published |
| | | | in 1982. It is based on the urban and |
| | | | rural life of the Northern Shaanxi |
| | | | Plateau during the reform period. It |
| | | | describes the life changing process of |
| | | | high school graduate Gao Jialin |
| | | | returning to the land, leaving the land, |
| | | | and then returning to the land . . . |
| Alive | Yu Hua | 28 | “Living” (new edition) tells the tragic |
| | | | life experiences of the rural people |
| | | | Fugui. Fugui was a rich young master, |
| | | | however, he is addicted to gambling as |
| | | | life, and finally gambled away his |
| | | | family business and was impoverished. |
| | | | His father died of anger with him, and |
| | | | his mother was seriously ill in poverty. |
| | | | Fugui went to seek medicine, but was |
| | | | caught as an able-bodied man by the |
| | | | Kuomintang on the way . . . |
| Brothers | Yu Hua | 46 | This is a novel born after two eras met. |
| | | | The former is the story of the Cultural |
| | | | Revolution. It is an era of spiritual |
| | | | fanaticism, instinct suppression and |
| | | | tragic fate, which is equivalent to the |
| | | | medieval Europe. The latter is a present |
| | | | story. It is an era of ethical subversion, |
| | | | impetuous indulgence and all living |
| | | | beings, even more than today's |
| | | | Europe . . . |

Optionally, determining two or more sorts of attribute information corresponding to the table body from the header includes: when the attributes corresponding to header contents of multiple columns of data are the same, summarizing the header contents of the multiple columns of data into one sort of attribute information; when header contents of only one column of data correspond to one attribute, directly taking the header contents of the one column data as one sort of attribute information.

The header contents of multiple columns of data are compared to determine whether attributes corresponding to the header contents of the multiple columns of data are the same. When the same, the header contents of the multiple columns of data are summarized into one sort of attribute information (for example, the header contents of other columns except the first column in Table 1 are specific days, which can be summarized into a sort of attribute information, and the attribute information can be represented by “financial term”). When header contents of only one column of data correspond to an attribute, the header contents of the column is directly taken as one sort of attribute information. For example, the primary key column has a single attribute and header contents of the column can be used as a sort of attribute information (e.g. the first column in Table 1 corresponds to a sort of attribute information which can be “financial product”). Of course, in other columns, there may be only one column of data corresponds to one attribute (for example, the attribute of the second column in Table 2 is the author name, and the attribute of the third column is the price, which cannot be summarized into a same attribute information, that is, each column corresponds to one sort of attribute information respectively). By summarizing attribute information, it provides a basis for automatically generating question and answer knowledge points, which can automatically generate few question and answer knowledge points, improve the efficiency of generating knowledge points and save storage space.

Step 130: generating one or more question and answer knowledge points according to the attribute information, each question and answer knowledge point including a question expression and an answer expression, and the answer expression including the title.

When there are only two sorts of attribute information, a question and answer knowledge point is generated; when there are M (M is greater than or equal to 3) sorts of attribute information, a question and answer knowledge point may be generated based on any two of the M sorts of attribute information, may be based on any three sorts of attribute information, and may also be generated based on any N (N is greater than 3 and less than or equal to M) sorts of attribute information. That is, one question and answer knowledge point may be generated based on two or more sorts of attribute information, and multiple question and answer knowledge points may be generated by combining the attribute information.

The answer expression in the question and answer knowledge point in the embodiment of the present invention includes the title of the structured data, which is used to search the structured data corresponding to the title and obtain the answer when interacting with the user.

Step 140: storing the structured data, the question and answer knowledge points and the attribute information into a repository.

In addition to the above structured data, question and answer knowledge points and attribute information, the repository may also include common knowledge points. The common knowledge points include question expressions and answer expressions, and the answer expressions do not include the title.

Since the structured data may include static two-dimensional tables or dynamic database tables, the structured data may be separately stored according to whether the structured data is static or dynamic. When the structured data is a static two-dimensional table, the static two-dimensional table may be directly stored; when the structured data is a dynamic database table, only the link information of the database corresponding to the dynamic database table may be stored.

In the method for establishing an intelligent question answering repository according to the embodiment of the present invention, two or more sorts of attribute information corresponding to the table body are determined from the header of the structured data by obtaining structured data, one or more question and answer knowledge points are generated according to the attribute information. Each question and answer knowledge point includes a question expression and an answer expression, and the answer expression includes the title. The structural data, question and answer knowledge points and attribute information are stored into the repository. In this way, automatic generation of knowledge points based on the structured data and the establishment of the corresponding repository are realized, which reduces the workload of operators and the possibility of human error, and improves the accuracy and efficiency of generating knowledge points.

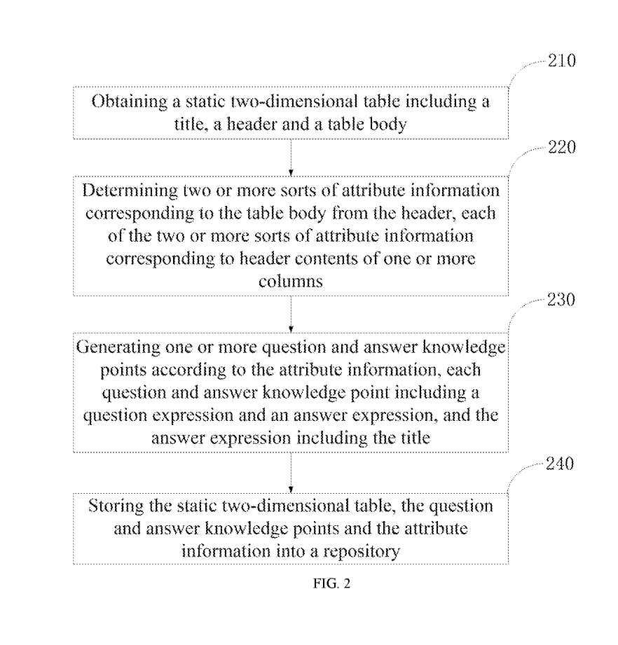

FIG. 2 is a flowchart illustrating a method for establishing an intelligent question answering repository according to a specific embodiment of the present invention. This embodiment can be applied to establishing an intelligent question answering repository on a static two-dimensional table. As shown in FIG. 2, the method specifically includes the following steps:

Step 210: obtaining a static two-dimensional table including a title, a header and a table body.

The static two-dimensional table is data that is logically expressed and implemented by a two-dimensional table structure. It follows the data formats and length specifications, is mainly stored and managed by a relational database, and includes a title, a header (the first row of the static two-dimensional table) and a table body (rows other than the first row of the static two-dimensional table).

In this embodiment, the static two-dimensional table is directly imported and displayed by loading the function of the two-dimensional table.

Step 220: determining two or more sorts of attribute information corresponding to the table body from the header, each of the two or more sorts of attribute information corresponding to header contents of one or more columns.

The header of the static two-dimensional table represents the attribute of each column of data. Generally, the primary key column contains one attribute. The attributes of other columns of data may be the same or different. The two or more sorts of attribute information corresponding to the table body can be determined according to the attribute of each column of data, and each sort of attribute information represents an attribute and corresponds to the header contents of one or more columns.

Step 230: generating one or more question and answer knowledge points according to the attribute information, each question and answer knowledge point including a question expression and an answer expression, and the answer expression including the title.

When there are only two sorts of attribute information, a question and answer knowledge point is generated; when there are M (M is greater than or equal to 3) sorts of attribute information, a question and answer knowledge point may be generated based on any two of the M sorts of attribute information, may be based on any three sorts of attribute information, and may also be generated based on any N (N is greater than 3 and less than or equal to M) sorts of attribute information. That is, one question and answer knowledge point may be generated based on two or more sorts of attribute information, and multiple question and answer knowledge points may be generated by combining the attribute information.

The answer expression in the question and answer knowledge point in the embodiment of the present invention includes the title of the static two-dimensional table, which is used to search the static two-dimensional table corresponding to the title and obtain the answer when interacting with the user.

Step 240: storing the static two-dimensional table, the question and answer knowledge points and the attribute information into a repository.

In addition to the above static two-dimensional table, question and answer knowledge points and attribute information, the repository may also include common knowledge points. The common knowledge points include question expressions and answer expressions, and the answer expressions do not include the title.

In the method according to the embodiment of the present invention, two or more sorts of attribute information corresponding to the table body are determined from the header of the static two-dimensional table by obtaining the static two-dimensional table, one or more question and answer knowledge points are generated according to the attribute information. Each question and answer knowledge point includes a question expression and an answer expression, and the answer expression includes the title. The static two-dimensional table, question and answer knowledge points and attribute information are stored into the repository. In this way, automatic generation of knowledge points based on the static two-dimensional table and the establishment of the corresponding repository are realized, which reduces the workload of operators and the possibility of human error, and improves the accuracy and efficiency of generating knowledge points.

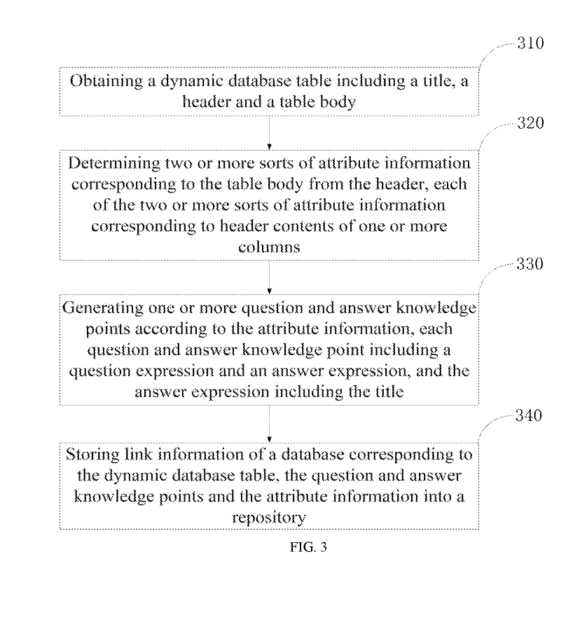

FIG. 3 is a flowchart illustrating a method for establishing an intelligent question answering repository according to another specific embodiment of the present invention. This embodiment can be applied to establishing an intelligent question answering repository on a dynamic database table. As shown in FIG. 3, the method specifically includes the following steps:

Step 310: obtaining a dynamic database table including a title, a header and a table body.

The dynamic database table is data that is logically expressed and implemented by a two-dimensional table structure, follows the data formats and length specifications, is mainly stored and managed by a relational database, and includes a title, a header (the first row of the dynamic database table) and a table body (rows other than the first row of the dynamic database table).

In this embodiment, the dynamic database table is loaded and displayed through the link information of the dynamic database table.

Step 320: determining two or more sorts of attribute information corresponding to the table body from the header, each of the two or more sorts of attribute information corresponding to header contents of one or more columns.

The header of the dynamic database table represents the attribute of each column of data. Generally, the primary key column contains one attribute. The attributes of other columns of data may be the same or different. The two or more sorts of attribute information corresponding to the table body can be determined according to the attribute of each column of data, and each sort of attribute information represents an attribute and corresponds to the header contents of one or more columns.

Step 330: generating one or more question and answer knowledge points according to the attribute information, each question and answer knowledge point including a question expression and an answer expression, and the answer expression including the title.

When there are only two sorts of attribute information, a question and answer knowledge point is generated; when there are M (M is greater than or equal to 3) sorts of attribute information, a question and answer knowledge point may be generated based on any two of the M sorts of attribute information, may be based on any three sorts of attribute information, and may also be generated based on any N (N is greater than 3 and less than or equal to M) sorts of attribute information. That is, one question and answer knowledge point may be generated based on two or more sorts of attribute information, and multiple question and answer knowledge points may be generated by combining the attribute information.

The answer expression in the question and answer knowledge point in the embodiment of the present invention includes the title of the dynamic database table, which is used to search the dynamic database table corresponding to the title and obtain the answer when interacting with the user.

Step 340: storing link information of a database corresponding to the dynamic database table, the question and answer knowledge points and the attribute information into a repository.

In this embodiment, only the link information of the database corresponding to the dynamic database table is stored, and then the dynamic database table can be obtained through the link information, which avoids the development of an additional interface to connect with the business system and reduces the workload.

In addition to the above link information of the database corresponding to the dynamic database table, question and answer knowledge points, and attribute information, the repository may also include common knowledge points. The common knowledge points include question expressions and answer expressions, and the answer expressions do not include the title.

In the method according to the embodiment of the present invention, two or more sorts of attribute information corresponding to the table body are determined from the header of the dynamic database table by obtaining the link information of the database corresponding to the dynamic database table, and one or more question and answer knowledge points are generated according to the attribute information. Each question and answer knowledge point includes a question expression and an answer expression, and the answer expression includes the title. The link information of the database corresponding to the dynamic database table, question and answer knowledge points and attribute information are stored into the repository. In this way, automatic generation of knowledge points based on the dynamic database table and the establishment of the corresponding repository are realized, which reduces the workload of operators and the possibility of human error, and improves the accuracy and efficiency of generating knowledge points. In addition, only the link information of the database corresponding to the dynamic database table is stored, and the dynamic database table can be subsequently obtained through the link information in this embodiment, which avoids the development of an additional interface to connect with the business system and further reduces the workload.

In an embodiment, the method may further include: establishing an inclusion relationship between the attribute information and the header contents or corresponding contents in the table body; and storing the inclusion relationship into the repository.

When the header content of one column of data is taken as one sort of attribute information, the inclusion relationship between the attribute information and the corresponding contents in the table body is established (for example, the inclusion relationship between the attribute information and the contents in the table body of the primary key column is established). When the header contents of multiple columns of data is summarized into one sort of attribute information, the attribute information may be a commonality of header contents of the multiple columns of data, therefore, an inclusion relationship between the attribute information and the corresponding header contents is established. The inclusion relationship between the attribute information and the corresponding contents in the table body and the inclusion relationship between the attribute information and the corresponding header contents are stored into the repository, so as to facilitate quick searching of corresponding knowledge points in intelligent question answering interaction with users.

In an embodiment, optionally, the method may further comprise: establishing word classes for words in the header or/and the table body, the words being used as word class names of the corresponding word classes, the word classes including the words and synonyms of the words. Establishing an inclusion relationship between the attribute information and the corresponding contents in the table body comprises: establishing an inclusion relationship between the attribute information and the corresponding word class names in the table body or header; and storing the inclusion relationship into the repository further comprises: storing the word classes into the repository.

In other word, in order to quickly match knowledge points when interacting with users, word classes can also be established for the words in the header or/and the table body. The word is taken as the word class name of the corresponding word class, synonyms of the word are determined, and the word is put under the word class together with the corresponding synonyms. When establishing the inclusion relationship between the attribute information and the corresponding contents in the table body, the inclusion relationship between the attribute information and the corresponding word class names in the table body or header may be established, and the inclusion relationship of the record is relatively simple. When storing the inclusion relationships, they are stored in the repository together with the established word classes.

Take Table 1 as an example, firstly, the primary key column is selected according to the contents of the header, and the column heading of the primary key column is taken as a sort of attribute information. The attribute information is a financial product. The values under the column are taken as the word class names under the attribute information, and the corresponding synonyms are added to enrich semantic information, so as to generate word classes. That is, word classes are established for the words in the first column in the table body, and the inclusion relationship between the attribute information and the corresponding word class names in the table body is established.

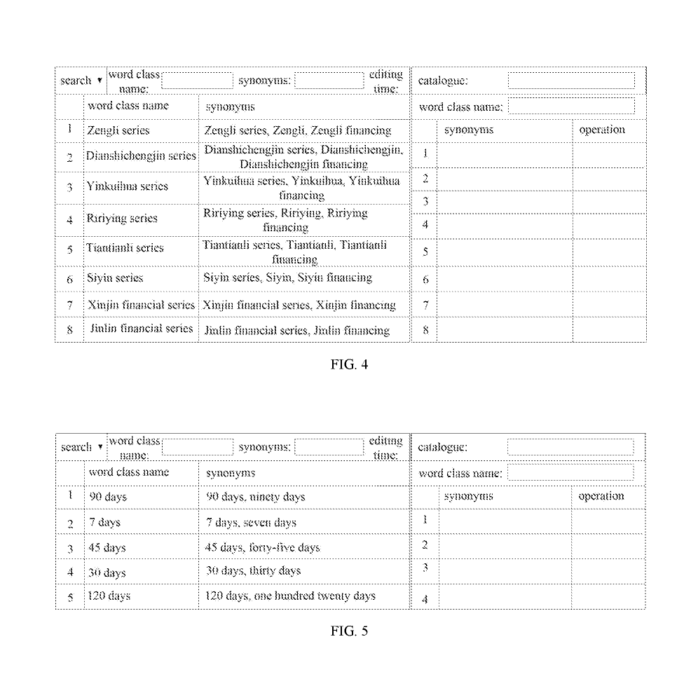

FIG. 4 is a schematic diagram illustrating establishing word classes for the primary key column of Table 1 in a method for establishing the intelligent question answering repository according to an embodiment of the present invention.

It is determined that the header contents of columns other than the primary key column are specific days through judging, the corresponding attributes are the same. The column headings of other columns are summarized and named as a sort of attribute information, and the attribute information is “financial term”. The column headings of other columns are taken as the word class names under the attribute information, and corresponding synonyms are added to generate word classes with the same number of columns as other columns. That is, word classes are established for the words in other columns of the header, and the inclusion relationship between the attribute information and the corresponding word class names in the header is established. FIG. 5 is a schematic diagram of establishing word classes for column headings of other columns of Table 1 in a method for establishing an intelligent question answering repository according to an embodiment of the present invention. The established word classes and inclusion relationships are stored into the repository.

Take Table 2 as an example, firstly, the primary key column is selected according to the header contents, the first column is taken as the primary key column, the column heading of the primary key column is taken as a sort of attribute information, and the values under the column are taken as the word class names under the attribute information. Corresponding synonyms are added to enrich semantic information, so as to generate word classes. That is, word classes are established for the words in the first column of the table body, and the inclusion relationship between the attribute information and the corresponding word class names in the table body is established. By judging, it is determined that the attributes corresponding to other columns other than the primary key column are different from each, in other words, each column corresponds to an attribute, and the column heading of each of other columns is summarized and named as a sort of attribute information. For example, the attribute information generated by the column “Author Name” can be “author name” or “author”, and the corresponding column heading is used as the word class name under the attribute information. At the same time, the words corresponding to the column in the table body are also used as word class names under the attribute information, and multiple word classes are established. That is, word classes are established for words in each column of the header and table body, and the inclusion relationships between attribute information and corresponding word class names in header and the body are established. According to the column headings in Table 2, four word class names can be generated as shown in Table 3: book name, author name, price and introduction.

TABLE 3
Word Classes

| | Word Class Name | Synonym |
|---|---|---|
| 1 | book name | book name, book |
| 2 | author | author name, author |
| 3 | price | price, selling price |
| 4 | introduction | introduction, brief introduction |

In an embodiment, generating one or more question and answer knowledge points according to the attribute information comprises: automatically generating an initial knowledge point according to at least two sorts of the attribute information; and adjusting each initial knowledge point to obtain a question and answer knowledge point.

Specifically, at least two sorts of attribute information are combined, an initial knowledge point is automatically generated, and each initial knowledge point is adjusted to obtain a question and answer knowledge point. For example, Table 1 can be summarized into two sorts of attribute information, i.e. financial product and financial term, and an initial knowledge point is automatically generated as follows:

Generating an initial question expression for the initial knowledge point: [financial product] [financial term]

Generating an initial answer expression for the initial knowledge point: $[financial product]'s $[financial term] is {ds. financial table}

For the above automatically generated initial knowledge point, the operator can modify and adjust it to obtain a question and answer knowledge point as follows:

The modified question expression: [financial product] [financial term] [annual interest rate] [how much?]

The modified answer expression: $[financial product]'s $[financial term] $[annual interest rate] is {ds. financial table}

For example, Table 2 can be summarized into multiple sorts of attribute information, and initial knowledge points can be generated based on attribute information of the primary key column and attribute information of one column in other columns. The generated initial knowledge points are as follows (answer expressions are omitted):

The generated question expression for knowledge point 1: [book name] [author] The generated question expression for knowledge point 2: [book name] [price] The generated question expression for knowledge point 3: [book name] [introduction]

The operator can simply modify the above knowledge points. For example, knowledge point 3 does not need to be modified, and knowledge point 1 and knowledge point 2 can be modified as follows:

The modified question expression for knowledge point 1: [book name] [author] [who?]

The modified question expression for knowledge point 2: [book name] [price] [how many?]

The initial knowledge points can also be generated based on the attribute information of one column in other columns and the attribute information of the primary key column, which can be (the answer expression is omitted):

Example: which books have been published by Lu Yao?

The generated question expression: [author name] [book]

The operator can modify it as follows:

The Modified question expression: [author name] [wrote| published] [book]

It can be seen that the initial knowledge points can be automatically generated according to the corresponding attribute information in the structured data, and the operator can obtain standard question and answer knowledge points only by simple adjustment, which greatly reduces the workload of the operator.

When Table 1 is processed by the technical solution according to the embodiment, only one question and answer knowledge point needs to be generated, thus it is no longer necessary to generate 40 knowledge points, which greatly saves storage space and reduces the workload of operators.

An embodiment of the invention also provides an intelligent question answering repository, which is established by the method for establishing the intelligent question answering repository according to the embodiment shown in FIG. 1. The intelligent question answering repository comprises:

one or more sets of structured data or link information of structured data, the structured data including a title, a header and a table body;

more than two sorts of attribute information corresponding to a set of the structured data; and

a plurality of question and answer knowledge points, each question and answer knowledge point including a question expression and an answer expression, and the answer expression including the title.

When the structured data is a static two-dimensional table, the static two-dimensional table is directly stored; when the structured data is a dynamic database table, link information of a database corresponding to the dynamic database table is stored.

In an embodiment, the repository may further include: an inclusion relationship between the attribute information and corresponding contents in the table body or header.

Optionally, when the repository is established, word classes are established for the words in the header or/and the table body, the words are used as word class names of the corresponding word classes, the word classes include the words and synonyms of the words. The inclusion relationship is an inclusion relationship between the attribute information and the corresponding word class names in the table body or the header. The repository further comprises the word classes.

In an embodiment, the intelligent question answering repository also stores common question and answer knowledge points, the common question and answer knowledge points include question expressions and answer expressions, and the answer expressions do not include the titles of structured data.

The intelligent question answering repository according to this embodiment directly stores the structured data and corresponding question and answer knowledge points. The question and answer knowledge points are obtained by summarizing common attributes of the structured data and cover a plurality of questions and answers. When interacting with users, corresponding answers can be returned according to specific situations.

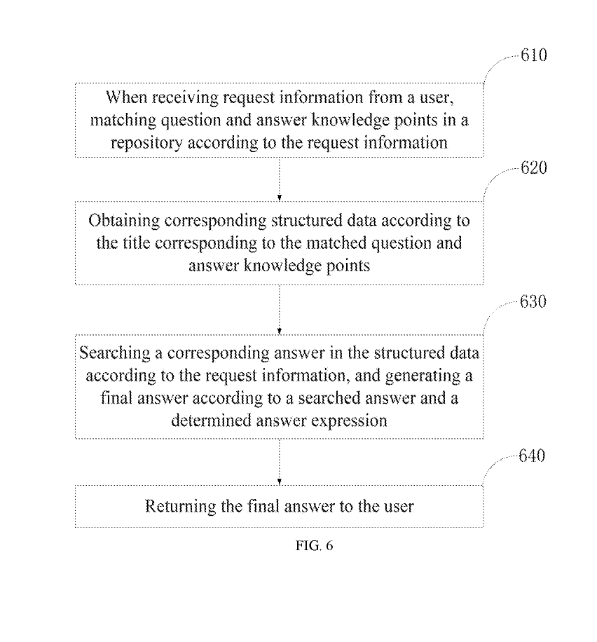

FIG. 6 is a flowchart illustrating an intelligent question answering method according to an embodiment of the present invention. The intelligent question answering method according to this embodiment is based on the intelligent question answering repository described in the above embodiments of the invention. This embodiment can be applied to intelligent question answering for data stored in structured data. The method can be implemented by an intelligent question answering apparatus. The apparatus can be implemented by software and/or hardware, and can be generally integrated in a server. The method specifically includes the following steps:

Step 610: when receiving request information from a user, matching question and answer knowledge points in a repository according to the request information.

The request information may be voice information or text information. When the request information is voice information, the voice information can be first converted into corresponding text information.

In an embodiment, when receiving request information from a user, the request information can be matched with question and answer knowledge points in the repository according to semantic similarity calculation, and one or more question and answer knowledge points whose similarities are greater than a preset threshold and the highest can be selected as matched question and answer knowledge points. It should be noted that the question and answer knowledge point here can be the question and answer knowledge point corresponding to the structured data. At this time, the answer expression of the question and answer knowledge point includes the title of the structured data. The question and answer knowledge point can also be a common knowledge point, and at this time, the answer expression of the question and answer knowledge point does not include the title.

When the similarity calculation is performed, word segmentation processing may be first implemented on the request information to obtain a segmentation result, and then the similarity is calculated based on word classes established by the segmentation result.

When the matched question and answer knowledge points are common knowledge points, the answer of the matched knowledge points can be directly obtained, and the answer can be returned to the user. It should be noted that when the answer is text information, the text information may be directly returned to the user, or the text information may be converted into voice information and then returned to the user, which does not affect the scope of protection of the present invention.

When the matching question and answer knowledge points are question and answer knowledge points corresponding to the structured data, the following steps need to be continued.

Step 620: obtaining corresponding structured data according to the title corresponding to the matched question and answer knowledge points.

In an embodiment, step 620 may specifically include the following:
searching a corresponding static two-dimensional table or link information of a database corresponding to a corresponding dynamic database table according to the title; and

obtaining the searched static two-dimensional table, or obtaining the corresponding dynamic database table according to the link information.

In other words, when obtaining structured data, if the structured data corresponding to the title is a static two-dimensional table, the static two-dimensional table with the title can be directly obtained; if the structured data corresponding to the title is a dynamic database table, link information of the database corresponding to the dynamic database table corresponding to the title is searched, and the corresponding dynamic database table is obtained according to the link information.

Step 630: searching a corresponding answer in the structured data according to the request information, and generating a final answer according to a searched answer and a determined answer expression.

Step 640: returning the final answer to the user.

Specifically, word class names in the structured data can be searched according to the word class names matched with the request information in the similarity calculation, and corresponding data can be obtained as an answer. A final answer is generated according to the searched answer and an answer expression of the matched question and answer knowledge points, and the final answer is returned to the user.

For example, in combination with Table 1, the request information from a user is “what is the annual interest rate of 90 days in the Dianshichengjin series?”, the matched question expression is “[financial product] [financial term] [annual interest rate] [how much?]” through the similarity calculation, and the answer expression is “$[financial product]'s $[financial term] $[annual interest rate] is {ds. financial table}”. The answer expression includes the title “financial table” of the structured data. According to the title of structured data, the static two-dimensional table is directly obtained when the structured data is a static two-dimensional table, and the dynamic database table is obtained according to the corresponding link information when the structured data is a dynamic database table. The specific data corresponding to 90 days and the Dianshichengjin series is searched in the static two-dimensional table or the dynamic database table, and after searching, the specific data corresponding to the Dianshichengjin series and 90 days is 4.46. Substituting the answer expression, the final answer is “the annual interest rate of 90 days in the Dianshichengjin series is 4.46”. The final answer is returned to the user, or the final answer is converted into the corresponding voice information and returned to the user.

In the intelligent question answering method according to the embodiment, when receiving request information from a user, the question and answer knowledge points in the repository are matched. If the answer expression of the matched question and answer knowledge points does not include the title of the structured data, the corresponding answer can be directly returned. If the answer expression of the matched question and answer knowledge points includes the title, the corresponding structured data is obtained, the corresponding answer is searched in the structured data, and the final answer is generated according to the answer expression and returned to the user, so as to find the final answer corresponding to the user's request information according to the structured data and the corresponding question and answer knowledge points stored in the repository. Thus, when storing the question and answer knowledge points corresponding to the structured data, only the question and answer knowledge points corresponding to the attribute information of the structured data need to be stored, and it is not necessary to store a plurality of corresponding knowledge points as in the prior art, which greatly saves the storage space of the repository. Moreover, when matching the question and answer knowledge points in the repository according to the user's request information, since the number of question and answer knowledge points to be matched is small, the matching speed is improved, thereby improving the speed of obtaining the answer.

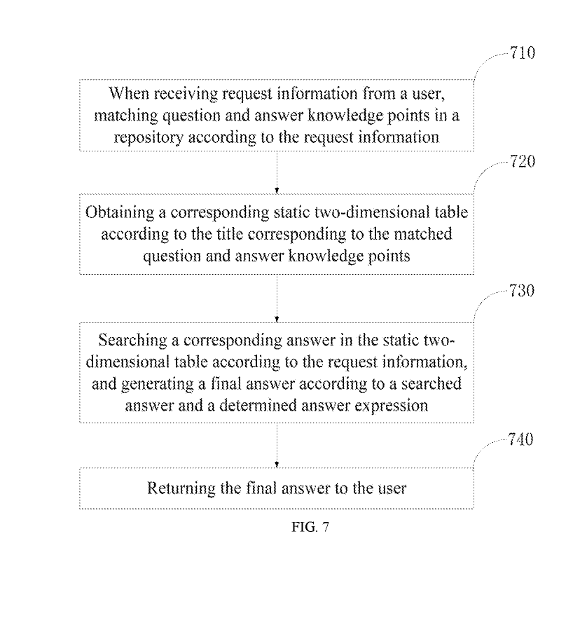

FIG. 7 is a flowchart illustrating an intelligent question answering method according to a specific embodiment of the present invention. The embodiment can be applied to intelligent question answering for data stored in a static two-dimensional table. The method can be executed by an intelligent question answering apparatus. The apparatus can be implemented by software and/or hardware, and can be integrated in a server. The method specifically comprises the following steps:

Step 710: when receiving request information from a user, matching question and answer knowledge points in a repository according to the request information.

The question and answer knowledge points here can be question and answer knowledge points corresponding to a static two-dimensional table. At this time, the answer expression of the question and answer knowledge points includes the title of the static two-dimensional table. The question and answer knowledge points can also be common knowledge points. At this time, the answer expression of the question and answer knowledge points does not include the title.

When the matched question and answer knowledge points are common knowledge points, the answer of the matched knowledge points can be directly obtained and returned to the user. When the answer is text information, the text information can be directly returned to the user, or the text information can be converted into voice information and then returned to the user.

When the matched question and answer knowledge points are question and answer knowledge points corresponding to the static two-dimensional table, the following steps need to be continued.

Step 720: obtaining a corresponding static two-dimensional table according to the title corresponding to the matched question and answer knowledge points.

Step 720 may specifically include: searching a corresponding static two-dimensional table according to the title; and obtaining the searched static two-dimensional table.

Step 730: searching a corresponding answer in the static two-dimensional table according to the request information, and generating a final answer according to a searched answer and a determined answer expression.

Step 740: returning the final answer to the user.

Specifically, word class names in the static two-dimensional table can be searched according to the word class names matched with the request information in the similarity calculation, and corresponding data can be obtained as an answer. A final answer is generated according to the searched answer and an answer expression of the matched question and answer knowledge points, and the final answer is returned to the user.

In the intelligent question answering method according to the embodiment, when receiving request information from a user, the question and answer knowledge points in the repository are matched. If the answer expression of the matched question and answer knowledge points does not include the title of the static two-dimensional table, the corresponding answer can be directly returned. If the answer expression of the matched question and answer knowledge points includes the title, the corresponding static two-dimensional table is obtained, the corresponding answer is searched in the static two-dimensional table, and the final answer is generated according to the answer expression and returned to the user, so as to find the final answer corresponding to the user's request information according to the static two-dimensional table and the corresponding question and answer knowledge points stored in the repository. Thus, when storing the question and answer knowledge points corresponding to the static two-dimensional table, only the question and answer knowledge points corresponding to the attribute information of the static two-dimensional table need to be stored, which greatly saves the storage space of the repository and improves the matching speed, thereby the speed of obtaining the answer is improved.

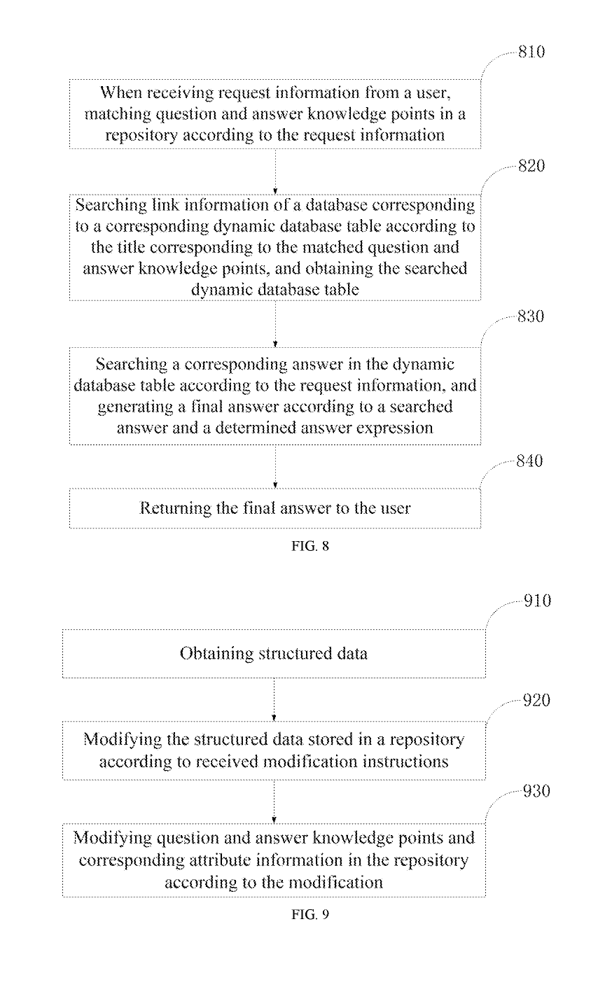

FIG. 8 is a flowchart illustrating an intelligent question answering method according to another specific embodiment of the present invention. The embodiment can be applied to intelligent question answering for data stored in a dynamic database table. The method can be executed by an intelligent question answering apparatus. The apparatus can be implemented by software and/or hardware, and can be integrated in a server. The method specifically includes the following steps:

Step 810: when receiving request information from a user, matching question and answer knowledge points in a repository according to the request information.

The question and answer knowledge points here can be question and answer knowledge points corresponding to a dynamic database table. At this time, the answer expression of the question and answer knowledge points includes the title of the dynamic database table. The question and answer knowledge points can also be common knowledge points. At this time, the answer expression of the question and answer knowledge points does not include the title.

When the matched question and answer knowledge points are common knowledge points, the answer of the matched knowledge points can be directly obtained and the answer can be returned to the user.

When the matched question and answer knowledge points are question and answer knowledge points corresponding to the dynamic database table, the following steps need to be continued.

Step 820: searching link information of a database corresponding to a corresponding dynamic database table according to the title corresponding to the matched question and answer knowledge points, and obtaining the searched dynamic database table.

Step 820 may specifically include: searching link information of a database corresponding to a corresponding dynamic database table according to the title; and obtaining a dynamic database table according to the searched link information.

Step 830: searching a corresponding answer in the dynamic database table according to the request information, and generating a final answer according to a searched answer and a determined answer expression.

Step 840: returning the final answer to the user.

Specifically, word class names in the dynamic database table can be searched according to the word class names matched with the request information in the similarity calculation, and corresponding data can be obtained as an answer. A final answer is generated according to the searched answer and an answer expression in the matched question and answer knowledge points, and the final answer is returned to the user.

In the intelligent question answering method according to the embodiment, when receiving request information from a user, the question and answer knowledge points in the repository are matched. If the answer expression of the matched question and answer knowledge points does not include the title of the dynamic database table, the corresponding answer can be directly returned. If the answer expression of the matched question and answer knowledge points includes the title, the corresponding dynamic database table is obtained, the corresponding answer is searched in the dynamic database table, and the final answer is generated according to the answer expression and returned to the user, so as to find the final answer corresponding to the user's request information according to the dynamic database table corresponding to the link information and the corresponding question and answer knowledge points stored in the repository. Thus, when storing the question and answer knowledge points corresponding to the dynamic database table, only the question and answer knowledge points corresponding to the attribute information of the dynamic database table need to be stored, which greatly saves the storage space of the repository and improves the matching speed, thereby the speed of obtaining the answer is improved.

FIG. 9 is a flowchart illustrating a method for modifying an intelligent question answering repository according to an embodiment of the present invention. The intelligent question answering repository to be modified in this embodiment is the intelligent question answering repository described in the above embodiments of the present invention. The embodiment can be applied to the modification of the intelligent question answering repository established according to structured data. The method can be implemented by an apparatus for modifying the intelligent question answering repository. The apparatus can be implemented by software and/or hardware and can be integrated in a terminal device. The method specifically comprises the following steps:

Step 910: obtaining structured data.

When the structured data is a static two-dimensional table, the static two-dimensional table is directly loaded and displayed, which facilitates the operator to modify the data therein. When the structured data is a dynamic database table, the dynamic database table is obtained and displayed according to link information of the dynamic database table, which is convenient for the operator to modify the data therein.

Step 920: modifying the structured data stored in a repository according to received modification instructions.

In this embodiment, the structured data can be modified arbitrarily. Specifically, the modification instruction may include: at least one of modifying the title, modifying the header content, modifying the table body content, increasing the entire column data, increasing the entire row data of the table body, deleting the entire row data of the table body, and deleting the entire column data.

It should be noted that the modification of the structured data can be an artificial modification, or an automatic modification of certain data due to changes in its influence factors.

Step 930: modifying question and answer knowledge points and corresponding attribute information in the repository according to the modification.

Specifically, when the modification of the structured data causes the modification of the attribute information, the question and answer knowledge points and the corresponding attribute information are modified; when modifying the title of the structured data, only the title in the answer expression of the corresponding question and answer knowledge point needs to be modified. For the most common case in which only the specific data in the table body is modified, no change in attribute information is caused, so no other modifications are needed.

In an embodiment, modifying question and answer knowledge points and corresponding attribute information in the repository according to the modification includes:

when the modification is to modify the title, modifying the title in the answer expression of the corresponding question and answer knowledge point; and

when the modification includes modifying, adding, and deleting the header content, modifying the corresponding attribute information and corresponding question and answer knowledge points.

Since the attribute information corresponds to header contents of one or more columns, when the modification includes modifying, adding, and deleting the header content, the attribute information may be changed. In this case, the corresponding attribute information and corresponding question and answer knowledge points can be modified, which specifically includes:

When the modification is to modify the header content, it is determined whether the attribute corresponding to the modified header content is included in the attribute information. If not, the corresponding attribute information and the corresponding question and answer knowledge points are modified, an inclusion relationship between the modified attribute information and the corresponding contents in the table body is established, and the inclusion relationship between the attribute information before modification and the corresponding contents in the table body is deleted. If the attribute corresponding to the modified header content is included in the attribute information, the attribute information and the corresponding question and answer knowledge points do not need to be modified, but the inclusion relationship between the attribute information and the header content needs to be modified. That is, the header content before modification is replaced with the modified header content in the inclusion relationship, and the corresponding word class is modified. Specifically, a word class is established for the word in the modified header content, and the word in the modified header content is used as the word class name of the word class, and synonyms of the word are added in the word class. When modifying the corresponding word class, the word class corresponding to the header content before the modification may be deleted to release the storage space.

When the modification is to add the entire column of data, it is determined whether the attribute corresponding to the header content of the added entire column of data is included in the attribute information. If not, the corresponding attribute information and corresponding question and answer knowledge points are added, the inclusion relationship between the added attribute information and the corresponding contents in the table body is established, word classes are respectively established for words in the added header content and table body contents, and the words in the added header content and table body contents are used as word class names. If the attribute corresponding to the header content of the added entire column of data is included in the attribute information, the attribute information and the corresponding question and answer do not need to be modified, but the inclusion relationship between the attribute information and the header content needs to be modified. That is, the inclusion relationship between the attribute information and the added header content is added in the inclusion relationship, a word class is established for the word in the added header content, the word in the added header content is used as the word class name of the word class, and synonyms of the word are added in the word class.

When the modification is to delete the entire column of data, it is determined whether the attribute corresponding to the header content of the deleted entire column of data is the same as the attribute corresponding to the header contents of other columns. If not, the corresponding attribute information and the corresponding question and answer knowledge points, the inclusion relationship between the attribute information and the corresponding contents in the table body, and word classes corresponding to words in the corresponding table body are deleted. If yes, the attribute information and the corresponding question and answer knowledge points do not need to be modified, but the inclusion relationship between the attribute information and the header content needs to be modified. That is, the inclusion relationship between the attribute information and the deleted header content in the inclusion relationship is deleted to release the storage space.

The modification includes not only modifying the title, modifying the header content, adding the entire column data and deleting the entire column data, but also modifying the table body content, adding the entire row data of the table body, or deleting the entire row data of the table body. The modification at this time will not cause changes in the attribute information, so there is no need to modify the question and answer knowledge points and the corresponding attribute information, only the corresponding word class needs to be modified, which specifically includes:

When the modification is to modify the table body content in the structured data, the word in the position corresponding to the modified table body content is determined, a word class named the word before modification is searched, the word class name corresponding to the word class is replaced with the modified word, and synonyms are modified. In the inclusion relationship between attribute information and the table body content, the table body content before modification is replaced with the modified table body content. When the specific data of the table body content (for example, 4.18 in Table 1 is modified to 4.2) is modified, the word class does not need to be modified.

When the modification is to increase the entire row data of the table body, word classes are established for the words therein according to the added whole row data, the words are used as the word class names of the word classes, and the word classes include the words and synonyms of the words. The words may be words in the primary key column or in other columns. The corresponding attribute information is determined according to the column in which the words in the added entire row data are located, and the inclusion relationship between the attribute information and the word class names corresponding to the words is increased.

When the modification is to delete the entire row of data of the table body, word classes named the words are determined according to the words included in the deleted entire row of data, the word classes are deleted, and the inclusion relationship between the attribute information and the word class names of the word classes is deleted from the inclusion relationship between the attribute information and the word class names.

Take Table 1 as an example, that is, Table 1 is a table before modification. When the content header “45 days” is changed to “60 days”, the corresponding attribute information is the same as the attribute information before modification, and is the “financial period”. Therefore, the attribute information does not need to be modified, and the corresponding question and answer knowledge points do not need to be modified.

However, in the inclusion relationship between the attribute information and the header content, the header content “45 days” before the modification needs to be replaced with the header content “60 days” after the modification, and the corresponding word class is modified. That is, the word class corresponding to “45 days” is deleted, and a word class corresponding to “60 days” is established.

When the added header content is the entire column of data corresponding to “60 days”, the attribute corresponding to the header content is included in the existing attribute information, i.e. in the attribute information “financial term”. Thus, there is no need to modify the attribute information and corresponding question and answer knowledge points, but the inclusion relationship between the attribute information and the header content needs to be modified, i.e. the inclusion relationship between the attribute information “financial term” and the added header content “60 days” is added into the inclusion relationship. Moreover, a word class is established for the word “60 days” in the added header content, the word “60 days” is used as the word class name of the word class, and synonyms of the word are added in the word class.

When the deleted header content is the entire column of data corresponding to “45 days”, the attribute information does not change, thus there is no need to modify the attribute information and corresponding question and answer knowledge points, but the inclusion relationship between the attribute information “financial term” and the header content needs to be modified. That is, the inclusion relationship between the attribute information “financial term” and the deleted header content “45 days” is deleted in the inclusion relationship, and the word class corresponding to the word “45 days” in the header content is deleted to release storage space.

When the table body content “Zengli series” is modified to “Zengzengli series”, the word class name “Zengli series” before the modification is replaced with the modified word “Zengzengli series”, the corresponding synonyms are modified, and the table body content “Zengli series” before the modification is replaced with the modified table body content “Zengzengli series” in the inclusion relationship between the attribute information and the table body content.

When adding the whole row of data corresponding to “Zengzengli series”, a word class named “Zengzengli series” is added, and corresponding synonyms are added. The column where the word “Zengzengli series” in the added whole row of data is located is the primary key column, and the attribute information corresponding to the primary key column is “financial product”. The inclusion relationship between the attribute information “financial product” and the word class name corresponding to “Zengzengli series” is established.

When deleting the entire row of data corresponding to “Zengli series”, the word class named “Zengli series” can be deleted, and the inclusion relationship between the attribute information “financial term” and the word class name “Zengli series” is deleted in the inclusion relationship between the attribute information and the word class name.

Now take Table 2 as an example, that is, Table 2 is a table before modification.

When the added header content is the entire column of data corresponding to “publication date”, the attribute corresponding to the column of data is the publication date, which is not included in the existing attribute information (book name, author name, price and introduction). The attribute information “publication date” is added and combined with the existing attribute information to generate question and answer knowledge points, and the inclusion relationship between the added attribute information “publication date” and corresponding contents in the table body is established. Word classes are established respectively for the added header content “publication date” and the words in the added table body content. The added header content “publication date” is used as the word class name of the corresponding word class, and the words in the added body content are used as the word class names of the corresponding word classes, and the corresponding synonyms are added in the corresponding word classes.

When the deleted header content is the entire column of data corresponding to “introduction”, the column of data corresponds to a single attribute information “introduction”. At this time, the corresponding attribute information “introduction” and corresponding question and answer knowledge points are deleted, and the inclusion relationship between the attribute information and the corresponding contents in the table body is deleted. Since the contents in the table body corresponding to the attribute information are not a single word, there is no corresponding word class, and there is no need to delete the corresponding word class.

When adding the whole row of data corresponding to “In the Name of People”, the modified table is as shown in Table 4, the word class named “In the Name of People” and corresponding synonyms are added, the word class named “Zhou Meisen” and corresponding synonyms are added. The attribute information corresponding to “In the Name of People” is determined as a book name, and the inclusion relationship between the attribute information “book name” and word class name “In the Name of People” is increased. The attribute information corresponding to “Zhou Meisen” is determined as an author name, and the inclusion relationship between the attribute information “author name” and word class name “Zhou Meisen” is increased.

When deleting the whole row of data corresponding to “Alive”, the word class named “Alive” and the corresponding synonyms are deleted. Since the corresponding author is Yu Hua, the author also wrote other book “Brothers”, therefore, there is no need to delete the word class named “Yu Hua”. The attribute information corresponding to “Alive” is the book name, and the inclusion relationship between the attribute information “book name” and the word class name “Alive” is deleted in the inclusion relationship between the attribute information and the word class name.

TABLE 4
Book Table

| Book Name | Author Name | Price | Introduce |
|---|---|---|---|
| The Ordinary | Lu Yao | 55 | “The Ordinary World” (3 volumes) is a |
| World | | | realist novel and a novelized family |
| | | | history. The writer highly concentrates |
| | | | the historical process of the countryside |
| | | | in the northwest of China. The work |
| | | | reached a high degree of unity between |
| | | | ideological and artistic. In particular, the |
| | | | protagonist's spirit of hard struggle in |
| | | | the face of difficulties still inspires the |
| | | | current college students . . . |
| Life | Lu Yao | 20 | “Life” is a novella of Lu Yao, published |
| | | | in 1982. It is based on the urban and |
| | | | rural life of the Northern Shaanxi |
| | | | Plateau during the reform period. It |
| | | | describes the life changing process of |
| | | | high school graduate Gao Jialin |
| | | | returning to the land, leaving the land, |
| | | | and then returning to the land . . . |
| Alive | Yu Hua | 28 | “Living” (new edition) tells the tragic |
| | | | life experiences of the rural people |
| | | | Fugui. Fugui was a rich young master, |
| | | | however, he is addicted to gambling as |
| | | | life, and finally gambled away his |
| | | | family business and was impoverished. |
| | | | His father died of anger with him, and |
| | | | his mother was seriously ill in poverty. |
| | | | Fugui went to seek medicine, but was |
| | | | caught as an able-bodied man by the |
| | | | Kuomintang on the way . . . |
| Brothers | Yu Hua | 46 | This is a novel born after two eras met. |
| | | | The former is the story of the Cultural |
| | | | Revolution. It is an era of spiritual |
| | | | fanaticism, instinct suppression and |
| | | | tragic fate, which is equivalent to the |
| | | | medieval Europe. The latter is a present |
| | | | story. It is an era of ethical subversion, |
| | | | impetuous indulgence and all living |
| | | | beings, even more than today's |
| | | | Europe . . . |
| In the Name of | Zhou Meisen | 50 | When Hou Liangping, the director of the |
| People | | | investigation department of |
| | | | Anti-Corruption General Administration |
| | | | of the Supreme People's Procuratorate, |
| | | | came to search for a project director of a |
| | | | national ministry who was reported to |
| | | | have received tens of millions of bribes, |
| | | | what he saw was that an “old farmer” |
| | | | with simple and honest appearance and |
| | | | plain dress was eating fried noodles in a |
| | | | shabby old house. When the mask of the |
| | | | corrupt official was finally torn open, |
| | | | the deputy mayor of Jingzhou city in H |
| | | | province, who was closely involved in |
| | | | the case . . . |

In the technical solution according to the embodiment, by acquiring and displaying structured data, modification instructions for the structured data is received to modify the structured data stored in the repository, and question and answer knowledge points and corresponding attribute information in the repository are modified according to the modification. In this way, When modifying the structured data, it is not necessary to modify each knowledge point, only the changed question and answer knowledge points need to be modified, thus greatly reducing the workload of the operator, and being convenient for maintenance. In addition, after the structural data is changed, it can be dynamically updated in the intelligent question answering.

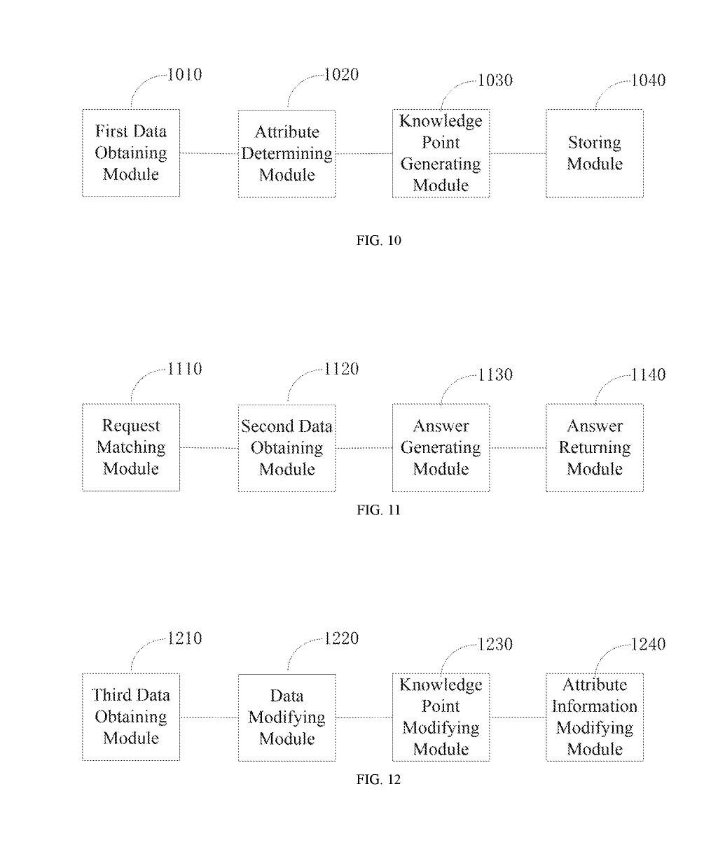

FIG. 10 is a schematic structural diagram illustrating an apparatus for establishing an intelligent question answering repository according to an embodiment of the present invention. This embodiment may be applied to establishing an intelligent question answering repository on structured data. The apparatus may be implemented by software and/or hardware, and may generally be integrated in a terminal device. As shown in FIG. 10, the apparatus includes a first data obtaining module 1010, an attribute determining module 1020, a knowledge point generating module 1030 and a storing module 1040.

The first data obtaining module 1010 is configured to obtain structured data which includes a title, a header and a table body.

The attribute determining module 1020 is configured to determine more than two sorts of attribute information corresponding to the table body from the header, and each sort of the attribute information corresponds to header contents of one or more columns.

The knowledge point generating module 1030 is configured to generate one or more question and answer knowledge points according to the attribute information. Each question and answer knowledge point comprises a question expression and an answer expression, and the answer expression comprises the title.

The storing module 1040 is configured to store the structured data, the question and answer knowledge points and the attribute information into a repository.

Optionally, the structured data includes a static two-dimensional table or a dynamic database table.

In an embodiment, the structured data comprises a static two-dimensional table, and the first data obtaining module 1010 is configured to obtain the static two-dimensional table. The static two-dimensional table comprises a title, a header and a table body. The header is the first row of the static two-dimensional table, and the table body includes other rows of the static two-dimensional table other than the first row. The storing module 1040 is configured to store the static two-dimensional table, the question and answer knowledge points and the attribute information into a repository. Specifically, the storing module 1040 may include a static two-dimensional table storing unit configured to store the static two-dimensional table.

In another embodiment, the structured data comprises a dynamic database table, and the first data obtaining module 1010 is configured to obtain the dynamic database table. The dynamic database table comprises a title, a header and a table body. The header is the first row of the dynamic database table, and the table body includes other rows of the dynamic database table other than the first row. The storing module 1040 is configured to store link information of a database corresponding to the dynamic database table, the question and answer knowledge points and the attribute information into a repository.

Specifically, the storing module 1040 may include a link information storing unit configured to store link information of the database corresponding to the dynamic database table into the repository.

In an embodiment, the attribute determining module 1020 may specifically include: a judging unit, configured to judge whether attributes corresponding to header contents of multiple columns of data are the same; an summarizing unit, configured to summarize header contents of multiple columns of data with a same attribute into one sort of the attribute information according to a judgment result of the judging unit; and an outputting unit, configured to output the attribute information obtained by the summarizing unit, and the header content of a column of data when the header content of the column of data corresponds to a single attribute.

In an embodiment, the apparatus further comprises: an inclusion relationship establishing module, configured to establish an inclusion relationship between the attribute information and corresponding contents in the table body; and an inclusion relationship storing module, configured to store the inclusion relationship into the repository.

In an embodiment, the apparatus further comprises a word class establishing module for establishing word classes for words in the header or/and the table body. The words are used as word class names of corresponding word classes, and the word classes include the words and synonyms of the words. In this embodiment, the inclusion relationship establishing module can be specifically used to establish the inclusion relationship between the attribute information and corresponding word class names in the table body or header. The inclusion relationship storing module is further configured to store the word classes into the repository.

In an embodiment, the knowledge point generating module 1030 includes: an initial knowledge generating unit, configured to automatically generate an initial knowledge point according to at least two sorts of the attribute information; and a knowledge point adjusting unit, configured to adjust each initial knowledge point to obtain the question and answer knowledge point.

The above apparatus for establishing the intelligent question answering repository can execute the method for establishing the intelligent question answering repository according to any embodiment of the invention, and has functional modules and beneficial effects corresponding to the method. For technical details that are not described in detail in this embodiment, please refer to the method for establishing an intelligent question answering repository according to any embodiment of the present invention.

FIG. 11 is a schematic structural diagram illustrating an intelligent question answering apparatus according to an embodiment of the present invention. The intelligent question answering apparatus described in this embodiment is based on the intelligent question answering repository described in the above embodiments of the present invention. This embodiment can be applied to intelligent question answering for data stored in structured data. The apparatus can be implemented by software and/or hardware and can be generally integrated in a server. As shown in FIG. 11, the apparatus includes a request matching module 1110, a second data obtaining module 1120, an answer generating module 1130 and an answer returning module 1140.

The request matching module 1110 is configured to match question and answer knowledge points in the repository according to the request information when receiving request information from a user.

In an embodiment, the request matching module 1110 matches the user's request information with question and answer knowledge points in the repository according to semantic similarity calculation, and selects one or more question and answer knowledge points whose similarities are greater than a preset threshold and the highest as matched question and answer knowledge points. Specifically, the semantic similarity calculation is performed by segmenting the request information and is calculated based on word classes established by the segmentation result.

The second data obtaining module 1120 is configured to obtain corresponding structured data according to the title corresponding to the matched question and answer knowledge points.

In an embodiment, the second data obtaining module 1120 includes: a searching unit, configured to search a corresponding static two-dimensional table or link information of a database corresponding to a corresponding dynamic database table according to the title; a data obtaining unit, configured to obtain the searched static two-dimensional table or obtain the corresponding dynamic database table according to the link information.

The answer generating module 1130 is configured to search a corresponding answer in the structured data according to the request information, and generate a final answer according to a searched answer and a determined answer expression.

The answer returning module 1140 is configured to return the final answer to the user.

The above intelligent question answering apparatus can execute the intelligent question answering method according to any embodiment of the invention, and has functional modules and beneficial effects corresponding to the method. For technical details that are not described in detail in this embodiment, please refer to the intelligent question answering method according to any embodiment of the present invention.

FIG. 12 is a schematic structural diagram illustrating an apparatus for modifying an intelligent question answering repository according to an embodiment of the present invention. The intelligent question answering repository to be modified in this embodiment is the intelligent question answering repository described in the above embodiments of the present invention. This embodiment can be applied to modifying an intelligent question answering repository established according to structured data. The apparatus can be implemented by software and/or hardware and can be generally integrated in terminal device. As shown in FIG. 12, the apparatus includes a third data obtaining module 1210, a data modifying module 1220, a knowledge point modifying module 1230 and an attribute information modifying module 1240.

The third data obtaining module 1210 is configured to obtain structured data. The data modifying module 1220 is configured to receive modification instructions for the structured data and modify the structured data stored in the repository according to the modification instructions. The knowledge point modifying module 1230 is configured to modify the question and answer knowledge points in the repository according to the modification. The attribute information modifying module 1240 is configured to modify attribute information in the repository according to the modification.

In an embodiment, the modification instruction includes: at least one of modifying the title, modifying the header content, modifying the table body content, increasing the entire column data, increasing the entire row data of the table body, deleting the entire row data of the table body and deleting the entire column data.

In an embodiment, the knowledge point modifying module 1230 is specifically configured to: modify the title in the answer expression of the corresponding question and answer knowledge point when the modification is to modify the title; and modify the corresponding question and answer knowledge point when the modification includes modifying, adding, and deleting the header content. The attribute information modifying module 1240 is specifically configured to modify the corresponding attribute information when the modification includes modifying, adding, and deleting the header content.

The above apparatus for modifying the intelligent question answering repository can execute the method for modifying the intelligent question answering repository according to any embodiment of the invention, and has functional modules and beneficial effects corresponding to the method. For technical details that are not described in detail in this embodiment, please refer to the method for modifying the intelligent question answering repository according to any embodiment of the present invention.

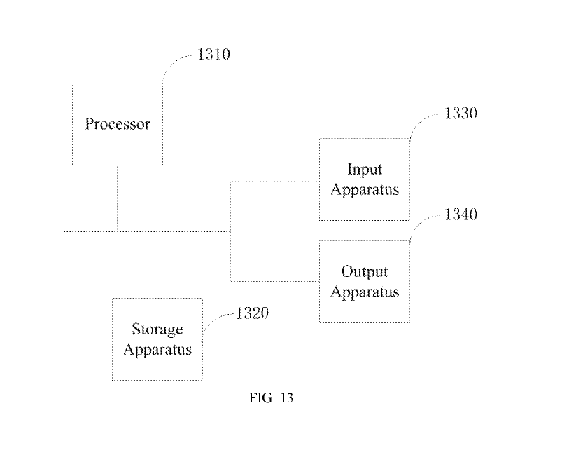

FIG. 13 is a schematic structural diagram illustrating a terminal device according to an embodiment of the present invention. As shown in FIG. 13, the terminal device includes a processor 1310, a storage apparatus 1320, an input apparatus 1330 and an output apparatus 1340. The number of processors 1310 in the terminal device may be one or more, and one processor 1310 is taken as an example in FIG. 13. The processor 1310, the storage apparatus 1320, the input apparatus 1330 and the output apparatus 1340 in the terminal device may be connected by a bus or other means, and the bus connection is taken as an example in FIG. 13.

As a computer readable storage medium, the storage apparatus 1320 can be used to store software programs, computer executable programs and modules, such as program instructions/modules (for example, the first data obtaining module 1010, the attribute determining module 1020, the knowledge point generating module 1030 and the storing module 1040 in the apparatus for establishing the intelligent question answering repository) corresponding to the method for establishing the intelligent question answering repository in the embodiments of the present invention. The processor 1310 executes various functional applications and data processing of the terminal device by running software programs, instructions and modules stored in the storage apparatus 1320, so as to realize the above-mentioned method for establishing an intelligent question answering repository.

The storage apparatus 1320 may mainly include a program storage area and a data storage area. The program storage area may store an operating system and application programs required for at least one function. The data storage area may store data created according to the use of the terminal, and the like. In addition, the storage apparatus 1320 may include a high-speed random access memory, and may also include a non-volatile memory, such as at least one disk storage apparatus, flash memory apparatus, or other non-volatile solid state storage apparatus. In some examples, the storage apparatus 1320 may further include memory remotely located relative to the processor 1310, which may be connected to the terminal device through a network. Examples of the above network include, but are not limited to, an internet, an intranet, a local area network, a mobile communication network and combinations thereof.

The input apparatus 1330 can be used to receive input digital or character information, and generated key signal inputs related to user settings and function control of the terminal device. The output apparatus 1340 may include a display device such as a display screen.

An embodiment of the present invention also provides a storage medium including computer executable instructions. The computer executable instructions are used for executing a method of establishing an intelligent question answering repository when executed by a computer processor. The method comprises the following steps:

obtaining structured data, the structured data comprising a title, a header and a table body;

determining more than two sorts of attribute information corresponding to the table body from the header, each attribute information corresponding to header contents of one or more columns;

generating one or more question and answer knowledge points according to the attribute information, each question and answer knowledge point comprising a question expression and an answer expression, and the answer expression comprising the title; and

storing the structured data, the question and answer knowledge points and the attribute information into a repository.

The computer executable instructions included in the storage medium according to the embodiment of the present invention are not limited to the method operations described above, and may also perform related operations in the method for establishing an intelligent question answering repository according to any embodiment of the present invention.

Another embodiment of the present invention provides a terminal device which may have the structure shown as FIG. 13. That is, the terminal device includes a processor, a storage apparatus, an input apparatus and an output apparatus. The number of processor in the terminal device may be one or more. The processor, the storage apparatus, the input apparatus and the output apparatus in the terminal device may be connected by bus or other means.

As a computer readable storage medium, the storage apparatus can be used to store software programs, computer executable programs and modules, such as program instructions/modules (e.g., the third data obtaining module 1210, the data modifying module 1220, the knowledge point modifying module 1230 and the attribute information modifying module 1240 in the apparatus for modifying the intelligent question answering repository) corresponding to the method for modifying the intelligent question answering repository in the embodiments of the present invention. The processor executes various functional applications and data processing of the terminal device by running software programs, instructions and modules stored in the storage apparatus so as to realize the above-mentioned method for modifying the intelligent question answering repository.

An embodiment of the present invention also provides a storage medium including computer executable instructions. The computer executable instructions are used for executing a method for modifying an intelligent question answering repository when executed by a computer processor. The method comprising the following steps:

obtaining and displaying structured data;

receiving modification instructions for the structured data, and modifying the structured data stored in a repository according to the modification instructions; and

modifying question and answer knowledge points and corresponding attribute information in the repository according to the modification.

The computer executable instructions included in the storage medium according to the embodiment of the present invention are not limited to the method operations described above, and may also perform related operations in the method for modifying the intelligent question answering repository according to any embodiment of the present invention.

Those skilled in the art can clearly understand that the embodiments of the present invention can be implemented by means of software and necessary general hardware through the above description of the implementation, of course, they can also be implemented by hardware, but in many cases the former is a better implementation. Based on this understanding, the essential part or the part contributing to the prior art of technical solutions of the present invention may be embodied in the form of a software product. The computer software product may be stored in a storage medium, and includes several instructions to enable a computer device (which may be a personal computer, a server, or a network device) to execute the methods described in the embodiments of the present invention or some parts of the embodiments. The foregoing storage medium includes any medium that may store program code, such as a U-disk, a removable hard disk, a read-only memory (ROM), a random access memory (RAM), a magnetic disk or an optical disk.

It should be noted that each unit and module included in the embodiments of the above-mentioned apparatus is only divided according to the functional logic, but is not limited to the above-mentioned division, as long as the corresponding function can be realized. In addition, the specific name of each functional unit is only for convenience of distinguishing from each other and is not intended to limit the scope of protection of the present invention.

The above descriptions are merely preferred specific embodiments of the present invention, and the protection scope of the present invention is not limited thereto. Variations or alternatives that may be easily derived by those skilled in the art within the technical scope disclosed by the present invention should fall in the protection scope of the present invention. Therefore, the protection scope of the present invention shall be based on the protection scope of the claims.

What is claimed is:

1. A method for establishing an intelligent question answering repository, comprising:
obtaining structured data including a title, a header and a table body;
determining two or more sorts of attribute information corresponding to the table body from the header, each of the two or more sorts of attribute information corresponding to header contents of one or more columns;
generating one or more question and answer knowledge points according to the attribute information, each question and answer knowledge point including a question expression and an answer expression, and the answer expression including the title; and
storing the structured data, the question and answer knowledge points and the attribute information into a repository.

2. The method of claim 1, wherein the structured data comprises a static two-dimensional table,
the obtaining structured data including a title, a header and a table body comprises: obtaining a static two-dimensional table including a title, a header and a table body, the header being the first row of the static two-dimensional table, and the table body being rows other than the first row of the static two-dimensional table; and
the storing the structured data, the question and answer knowledge points and the attribute information into a repository comprises: storing the static two-dimensional table, the question and answer knowledge points and the attribute information into a repository.

3. The method of claim 1, wherein the structured data comprises a dynamic database table,
the obtaining structured data including a title, a header and a table body comprises: obtaining a dynamic database table including a title, a header and a table body, the header being the first row of the dynamic database table, and the table body being rows other than the first row of the dynamic database table; and
the storing the structured data, the question and answer knowledge points and the attribute information into a repository comprises: storing link information of a database corresponding to the dynamic database table, the question and answer knowledge points and the attribute information into a repository.

4. The method according to claim 1, wherein the determining two or more sorts of attribute information corresponding to the table body from the header comprises:
when attributes corresponding to header contents of multiple columns of data are the same, summarizing the header contents of the multiple columns of data into one sort of attribute information; and
when header contents of only one column of data correspond to one attribute, directly taking the header contents of the one column data as one sort of attribute information.

5. The method of claim 4, further comprising:
establishing an inclusion relationship between the attribute information and the header contents or corresponding contents in the table body; and
storing the inclusion relationship into the repository.

6. The method of claim 5, further comprising:
establishing word classes for words in the header and/or the table body, the words being used as word class names of corresponding word classes, and the word classes including the words and synonyms of the words;
wherein the establishing an inclusion relationship between the attribute information and corresponding contents in the table body comprises: establishing an inclusion relationship between the attribute information and corresponding word class names in the table body or header; and
the storing the inclusion relationship into the repository further comprises: storing the word classes into the repository.

7. The method according to claim 1, wherein the generating one or more question and answer knowledge points according to the attribute information comprises:
automatically generating an initial knowledge point according to at least two sorts of the attribute information; and
adjusting each initial knowledge point to obtain a question and answer knowledge point.

8. The method according to claim 1, wherein the repository further comprises common knowledge points, the common knowledge points comprise question expressions and answer expressions, and the answer expressions do not include the title.

9. An intelligent question answering method based on a repository, the repository being established by the method for establishing an intelligent question answering repository of claim 1, the intelligent question answering method comprises:
when receiving request information from a user, matching question and answer knowledge points in a repository according to the request information;
obtaining corresponding structured data according to a title corresponding to matched question and answer knowledge points;
searching a corresponding answer in the structured data according to the request information, and generating a final answer according to a searched answer and a determined answer expression; and
returning the final answer to the user.

10. The method according to claim 9, wherein the matching question and answer knowledge points in a repository according to the request information comprises:
matching the request information from a user with question and answer knowledge points in the repository according to semantic similarity calculation, and selecting one or more question and answer knowledge points whose similarities are greater than a preset threshold and the highest as matched question and answer knowledge points.

11. The method according to claim 10, wherein the semantic similarity calculation is performed by word segmentation on the request information and is calculated based on word classes established by a word segmentation result.

12. The method according to claim 9, wherein the obtaining corresponding structured data according to a title corresponding to matched question and answer knowledge points comprises:
searching a corresponding static two-dimensional table or link information of a database corresponding to a corresponding dynamic database table according to the title; and
obtaining a searched static two-dimensional table, or obtaining a corresponding dynamic database table according to the link information.

13. An apparatus for establishing an intelligent question answering repository, comprising:
a processor;
a memory for storing instructions executable by the processor;
wherein the processor executes the instructions to perform the following steps:
obtaining structured data including a title, a header and a table body;
determining two or more sorts of attribute information corresponding to the table body from the header, each of the two or more sorts of attribute information corresponding to header contents of one or more columns;
generating one or more question and answer knowledge points according to the attribute information, each question and answer knowledge point including a question expression and an answer expression, and the answer expression including the title; and
storing the structured data, the question and answer knowledge points and the attribute information into a repository.

14. The apparatus of claim 13, wherein the structured data comprises a static two-dimensional table,
the obtaining structured data including a title, a header and a table body comprises: obtaining a static two-dimensional table including a title, a header and a table body, the header being the first row of the static two-dimensional table, and the table body being rows other than the first row of the static two-dimensional table; and
the storing the structured data, the question and answer knowledge points and the attribute information into a repository comprises: storing the static two-dimensional table, the question and answer knowledge points and the attribute information into a repository.

15. The apparatus of claim 13, wherein the structured data comprises a dynamic database table,
the obtaining structured data including a title, a header and a table body comprises: obtaining a dynamic database table including a title, a header and a table body, the header being the first row of the dynamic database table, and the table body being rows other than the first row of the dynamic database table; and
the storing the structured data, the question and answer knowledge points and the attribute information into a repository comprises: storing link information of a database corresponding to the dynamic database table, the question and answer knowledge points and the attribute information into a repository.

16. The apparatus of claim 13, wherein the determining two or more sorts of attribute information corresponding to the table body from the header comprises:
when attributes corresponding to header contents of multiple columns of data are the same, summarizing the header contents of the multiple columns of data into one sort of attribute information; and
when header contents of only one column of data correspond to one attribute, directly taking the header contents of the one column data as one sort of attribute information.

17. The apparatus of claim 16, the processor executes the instructions to further perform the follow steps:
establishing an inclusion relationship between the attribute information and the header contents or corresponding contents in the table body; and
storing the inclusion relationship into the repository.

18. The apparatus of claim 17, the processor executes the instructions to further perform the follow step:
establishing word classes for words in the header and/or the table body, the words being used as word class names of corresponding word classes, and the word classes including the words and synonyms of the words;
wherein the establishing an inclusion relationship between the attribute information and corresponding contents in the table body comprises: establishing an inclusion relationship between the attribute information and corresponding word class names in the table body or header; and
the storing the inclusion relationship into the repository further comprises: storing the word classes into the repository.

19. The apparatus of claim 13, wherein the generating one or more question and answer knowledge points according to the attribute information comprises:
automatically generating an initial knowledge point according to at least two sorts of the attribute information; and
adjusting each initial knowledge point to obtain a question and answer knowledge point.

20. The apparatus of claim 13, wherein the repository further comprises common knowledge points, the common knowledge points comprise question expressions and answer expressions, and the answer expressions do not include the title.
